(19) United States
(12) Patent Application Publication
(10) Pub. No.: US 2013/0116966 A1
(43) Pub. Date: May 9, 2013

(54) DETERMINATION OF A LOCATION OF AN APPARATUS

(71) Applicants: German Jose D'Jesus Bencci, Staines Middlesex (GB); Ankur Khandelia, Staines Middlesex (GB); Rajiv Rajan Azhapilli, Staines Middlesex (GB)

(72) Inventors: German Jose D'Jesus Bencci, Staines Middlesex (GB); Ankur Khandelia, Staines Middlesex (GB); Rajiv Rajan Azhapilli, Staines Middlesex (GB)

(21) Appl. No.: 13/641,379

(22) PCT Filed: Apr. 13, 2011
(86) PCT No.: PCT/KR11/02645

§ 371 Date: Dec. 14, 2012

(30) Foreign Application Priority Data
Apr. 15, 2010 (GB) 1006308.9
Mar. 31, 2011 (GB) 1105542.3

(51) Int. Cl. G06F 15/00

(52) U.S. Cl. CPC G06F 15/00
USPC 702/150

(57) ABSTRACT

A method of determining a location of an apparatus relative to a previously determined location, the method comprising: detecting a change in motion of the apparatus by use of a sensor or sensors in the apparatus; determining a first estimate of the location of the apparatus at which said change of motion is detected, the first estimate of location being relative to the previously determined location, by use of at least one of said sensor or sensors; holding information relating to a plurality of reference points at which a change in motion is expected; determining that the detected change in motion relates to a first reference point of the plurality of reference points on a basis including the first estimate of the location and at least part of said information relating to the plurality of reference points; and re-setting the first estimate of location to a location of the first reference point.

### TECHNICAL FIELD

The present invention relates generally to determination of a location of an apparatus, and more specifically, but not exclusively, to a method and apparatus for determining a location relative to a previously determined location by the use of information relating to a plurality reference points at which a change in motion is expected, and to a method and apparatus for generating information relating to a plurality reference points at which a change in motion is expected.

### BACKGROUND ART

Many types of apparatus require the determination of a location relative to a previously determined position, and typically this may be achieved by the use of a sensor or sensors within the apparatus. For example, the apparatus may be a user equipment of wireless network, a hand held computing device, or a device intended primarily for navigation. The sensor or sensors may be for example a compass, an accelerometer, for example used as a pedometer, and an altimeter, which may be typically included within a user equipment of a wireless network. Typically a user equipment may also include a navigation system receiver, such as a satellite navigation receiver, for example a Global Positioning System (GPS) receiver. A relative navigation system may approximate the position of the apparatus if the navigation system receiver is unable to operate, for example indoors. For example, an accelerometer used as a pedometer in conjunction with a compass may be used to determine an approximate trajectory. However, such relative navigation systems are inherently inaccurate, and in particular they may suffer from an error in terms of position that increases, the greater the distance travelled since the last reliable fix using the navigation system.

Nevertheless, there may be a need to determine a location of the apparatus when the navigation system is not available. One such application relates to the gathering of information regarding the locations and signal strengths of wireless access points, which may be indoors. For example, a database may be generated and maintained for use to assist handover, typically identifying fixed wireless nodes operating according to a variety of radio access technologies, which are geographically dispersed, including identification data and location data for the wireless nodes. The stored database may become out of date, as wireless nodes are added or removed from a wireless network, or the characteristics of the wireless network change. Such a database may be held at a Media Independent Handover (MIH) server.

Aspects of the invention mitigate disadvantages of the prior art systems.

### DISCLOSURE OF INVENTION

### Technical Problem

In accordance with a first aspect of the present invention, there is provided a method of determining a location of an apparatus relative to a previously determined location, the method comprising:

detecting a change in motion of the apparatus by use of a sensor or sensors in the apparatus;

determining a first estimate of the location of the apparatus at which said change of motion is detected, the first estimate of location being relative to the previously determined location, by use of at least one of said sensor or sensors;

holding information relating to a plurality of reference points at which a change in motion is expected;

determining that the detected change in motion relates to a first reference point of the plurality of reference points on a basis including the first estimate of the location and at least part of said information relating to the plurality of reference points; and

re-setting the first estimate of location to a location of the first reference point.

In an embodiment of the invention, said detecting of a change of motion is on a basis including detecting a change in direction by use of a compass, an accelerometer, or an altimeter. Such devices may be used to conveniently detect a change in motion, and may be built in to a device such as a user equipment of a mobile network.

In an embodiment of the invention, the method comprises downloading said information relating to the plurality of reference points from a server system. This has an advantage that reference points may be obtained that have been generated by input from a history of movements of many user equipments, which may tend to reduce errors in location of the reference points due to averaging. It may be convenient to use a media independent handover (MIH) server system to download the information.

In an embodiment of the invention, said information relating to the plurality of reference points relates to a location of each of the reference points and/or includes information related to an expected change in motion at at least one reference point. This has an advantage that a match between the expected change in motion and the expected change in motion may aid reliability of the recognition of the reference point. For example, a turn may be a left turn or a right turn, or the change in motion may involve the apparatus being stationary at a work place or waiting at a lift shaft. This may relating to an expected output or change of output of at least one of said sensor or sensors at at least one reference point.

In an embodiment of the invention, said information includes a plan of a geographical area, for example a plan of a building.

In an embodiment of the invention, the method comprises determining the first estimate of the location of the apparatus by a method including the use of a measurement of received signal strength of at least one radio signal. For example, the detection of a radio signal known to be available at a given location may aid the estimate of the first location. Triangulation between known locations of radio transmitters may aid the first estimate of the location of the apparatus.

In an embodiment of the invention, the method comprises determining that the detected change in motion relates to the first reference point on a basis including a measurement of received signal strength of at least one radio signal. In an embodiment of the invention, said information relating to the plurality of reference points includes information relating to received signal strength of at least one radio signal. This has the advantage that comparing the received signal strength at the first reference point to that at the location where a change in motion was detected may aid the determination that the detected change in motion relates to the first reference point.

In an embodiment of the invention, said at least one radio signal is received from at least a wireless access point. This has the advantage that data may be available relating to the location and signal strength of wireless access points.

In an embodiment of the invention, said user equipment is located within a building and said wireless access point is located outside the building. If a wireless access point is outside a building, it may be received within a building at a limited number of locations, due to attenuation of radio signals through the walls, for example, and so the receipt of the signal may aid location.

In an embodiment of the invention, the method comprises:

downloading information relating to locations of a plurality of wireless access points from a server system; and

determining the first estimate of the location of the apparatus by a method including the use of a measurement of received signal strength of a radio signal received from at least one of said plurality of wireless access points and a location of said at least one of the plurality of access points.

In an embodiment of the invention, the method comprises downloading information relating to a location of a limitation to movement from a server system and determining the first estimate of the location of the apparatus by reference to said limitation to movement. The location of the limitation to movement may correspond to a location of a wall of a building. The location of limitations to movement, such as locations of walls, may be used to refine the first estimate of location, since it may be assumed that locations outside the limits of movement are in error.

In an embodiment of the invention, the method comprises downloading information relating to a plurality of floor plans of a building from a server system, said information relating to a plurality of floor plans of a building including a location of a reference point at which a change of floor is expected; and in dependence on the first reference point corresponding to a reference point at which a change of altitude is expected and in dependence on a history of movement of the apparatus, determining on which floor the apparatus is located. This provides a convenient method of determining on which floor of a building an apparatus is located, without relying only on an altimeter reading.

In an embodiment of the invention, the method comprises deciding whether or not to perform determination of the first estimate of the location of the apparatus in dependence on an output of at least one of said sensor or sensors. For example, the tracking of position using sensors may be disabled to save battery life, but the determining of the first estimate of the location may be triggered by recognition that a predetermined position has been reached by the detection of an output of a sensor. For example, a change in motion may be detected or a radio signal may be detected.

In an embodiment of the invention, the method comprises deciding whether or not to determine the first estimate of the location of the apparatus in dependence on at least one predetermined condition of the user equipment relating to availability of resources at the user equipment. For example, the determination of the first estimate of location may be restricted to an idle mode or super-idle mode, in which usage of a resource such as processor capacity or a communication resource is below a determined limit.

In an embodiment of the invention, the apparatus is a user equipment of a wireless communication network.

In accordance with a third aspect of the present invention, there is provided a method of generating information relating to a plurality of reference points at which a change in motion of an apparatus is expected, the method comprising:

detecting a change in motion of the apparatus by use of a sensor or sensors in the apparatus;

determining a first estimate of the location of the apparatus at which said change of motion is detected, the first estimate of location being relative to the previously determined location, by use of at least one of said sensor or sensors;

holding previously generated information relating to the plurality of reference points, the plurality of reference points corresponding to previously detected locations at which a change in motion of the apparatus has been detected;

determining that the detected change in motion relates to a first reference point of the plurality of reference points on a basis including the first estimate of the location and the previously generated information;

updating the previously generated information relating to the first reference point in view of the first estimate of the location and a previous estimate of the location of the first reference point, thereby generating updated information relating to the plurality of reference points.

In an embodiment of the invention, said updating is performed by averaging the previously generated information relating to the first reference point and the first estimate of the location. Various types of averaging may be used, such as a weighted average. This has the advantage of increasing the accuracy of the estimate of positions of reference points, by incorporating a large number of data points.

In an embodiment of the invention, the method comprises:

uploading said updated information relating to the plurality of reference points to a server system. This has an advantage that information relating to reference points may be made available to other apparatus such as other user equipment. In an embodiment of the invention, the server system is a media independent handover (MIH) server system.

In an embodiment of the invention, the method comprises uploading information relating to locations of a plurality of wireless access points to a server system. This has an advantage of adding to a database of locations of wireless access points, that may be used, for example for assisting handover.

In an embodiment of the invention, the method comprises:

uploading information relating to a location of a limitation to movement to a server system. The location of limitations to movement may correspond to a location of a wall of a building. The information relating to limits of movement may be compiled on the basis of a history of movement of the apparatus; it may be assumed that areas which are not visited in an extended period are outside a limit of movement, for example outside a building.

In an embodiment of the invention, the method comprises generating a floor plan of a building in dependence on a history of movement of the apparatus, and in dependence on the identification of a reference point at which a change of altitude has been measured; and

uploading information relating to a floor plan of a building to a server system, said information relating to a floor plan of a building including a location of a reference point at which a change of floor is expected.

In accordance with a fourth aspect of the present invention, there is provided apparatus arranged to generate information relating to a plurality of reference points at which a change in motion of the apparatus is expected, the apparatus being arranged to:

detect a change in motion of the apparatus by use of a sensor or sensors in the apparatus;

determine a first estimate of the location of the apparatus at which said change of motion is detected, the first estimate of location being relative to the previously determined location, by use of at least one of said sensor or sensors;

hold previously generated information relating to the plurality of reference points, the plurality of reference points corresponding to previously detected locations at which a change in motion of the apparatus has been detected;

determine that the detected change in motion relates to a first reference point of the plurality of reference points on a basis including the first estimate of the location and the previously generated information; and

update the previously generated information relating to the first reference point in view of the first estimate of the location and a previous estimate of the location of the first reference point, thereby generating updated information relating to the plurality of reference points.

In an embodiment of the invention the apparatus is a user equipment of a wireless communication network.

### Solution to Problem

In accordance with a second aspect of the present invention, there is provided an apparatus arranged to determine a location relative to a previously determined location, the apparatus being arranged to:

detect a change in motion of the apparatus by use of a sensor or sensors in the apparatus;

determine a first estimate of the location of the apparatus at which said change of motion is detected, the first estimate of location being relative to the previously determined location, by use of at least one of said sensor or sensors;

hold information relating to a plurality of reference points at which a change in motion is expected;

determine that the detected change in motion relates to a first reference point of the plurality of reference points on a basis including the first estimate of the location and at least part of said information relating to the plurality of reference points; and

re-setting the first estimate of location to a location of the first reference point.

In accordance with a fifth aspect of the present invention, there is provided processor arranged to process information relating to a plurality of reference points at which a change in motion of an apparatus is expected, the apparatus being arranged to detect a change in motion of the apparatus by use of a sensor or sensors in the apparatus and to determine a first estimate of the location of the apparatus at which said change of motion is detected, the first estimate of location being relative to the previously determined location, by use of at least one of said sensor or sensors, the processor being arranged to:

receive the first estimate of location from the apparatus;

hold previously generated information relating to the plurality of reference points, the plurality of reference points corresponding to previously detected locations at which a change in motion of the apparatus, or of further apparatus, has been detected;

determine that the detected change in motion relates to a first reference point of the plurality of reference points on a basis including the first estimate of the location and the previously generated information; and

update the previously generated information relating to the first reference point in view of the first estimate of the location and a previous estimate of the location of the first reference point, thereby generating updated information relating to the plurality of reference points.

### Advantageous Effects of Invention

This has an advantage that a tendency for errors in determining the location of the apparatus to accumulate is counteracted by resetting the first estimate to the first reference point, which may give a more reliable estimate of location, since the location of the first reference point may be determined more accurately than the first estimate of location. Motion may be expected to change at reliably repeatable points in many situation, such as within a building, where walkways, lift shafts and work places have defined locations.

This has an advantage that random errors may be reduced by combining many estimates of the location of the reference points.

Further features and advantages of the invention will be apparent form the following description of preferred embodiments of the invention, which are given by way of example only.

### BRIEF DESCRIPTION OF DRAWINGS

FIG. 1 is a schematic diagram showing a wireless network incorporating parts of a first radio access network and parts of a second radio access network;

FIG. 2 is a flow diagram illustrating a first embodiment of the invention;

FIG. 3 is a schematic diagram showing a relationship between signal strength and distance from a fixed wireless node;

FIG. 4 is a flow diagram illustrating a second embodiment of the invention;

FIG. 5 is a flow diagram illustrating a third embodiment of the invention;

FIG. 6 is a schematic diagram showing a history of movement of a user equipment within a building;

FIG. 7 is a flow diagram illustrating a fourth embodiment of the invention.

FIG. 8 is a schematic diagram showing a recorded path of a user equipment within a building;

FIG. 9 is a schematic diagram showing four recorded paths within a building;

FIG. 10 is a schematic diagram showing estimation of extreme points of movement within a building;

FIG. 11 is a schematic diagram showing estimation of positions of internal and external walls of a building; and

FIG. 12 is a flow diagram illustrating generation of a floor plan according to an embodiment of the invention.

### MODE FOR THE INVENTION

By way of example, embodiments of the invention will now be described in the context of determination of a location of an apparatus, where the apparatus is a user equipment of a wireless network. A location of the apparatus is determined relative to a previously determined location by the use of information relating to a plurality reference points at which a change in motion is expected. The information may be downloaded from a media independent handover (MIH) server. Also, the information relating to the plurality reference points at which a change in motion is expected is generated and uploaded to a media independent handover server. However, it should be understood that embodiments of the invention are not restricted to use with wireless networks, or to the use of a media independent handover server. For example, the apparatus may be a hand held computing device, or a device intended primarily for navigation.

In a first embodiment of the invention, a location of an apparatus, for example a user equipment of a wireless network, is determined relative to a previously determined location. This is done in part by detecting a change in motion of the apparatus by use of a sensor or sensors in the apparatus. So, for example, an accelerometer and/or compass may be used to detect that the user equipment has stopped moving, or turned left or right. It may be assumed that within a building, for example, the locations where certain types of change in motion are expected would be identifiable and repeatable for other users. For example, a turning point at the corner of a corridor may be recognisable from the change in motion. However, it is unlikely that a turning point will be uniquely identifiable by the characteristics of the change in motion alone; some estimate is useful of the rough location of the turning point. A first estimate is determined of the location of the apparatus at which said change of motion is detected relative to a previously determined location such as a previous GPS fix or a previously identified reference point, by use of at least one sensor or sensors. So, an accelerometer used as a pedometer, together with, for example, a compass, may be used to determine the first estimate.

The user equipment holds information relating to a number of reference points at which a change in motion is expected, which may have been compiled on the basis of past motion of the user equipment itself and refined by averaging of many measurements over time, or may have been downloaded from a server, such as a MIH server. It is then determined that the detected change in motion relates to one of the held reference points by comparing the first (rough) estimate of the location and the held information, e.g the information downloaded from the MIH server. Once it has been determined with a sufficient degree of confidence that the location of the detected change in motion corresponds with the first reference point, the first estimate of location is set to the location of the first reference point. In this way, the accuracy of the estimate of location is improved, since it is assumed that the downloaded information gives a more accurate estimate of the position of the first reference point than does the first estimate performed using the sensors of the user equipment. As a result of performing this technique repeatedly, the tendency for errors in determining the location of the apparatus to accumulate is counteracted by resetting each successive estimate to a reference point. Reference points may for example correspond to walkways, lift shafts and work places have defined locations.

The information that is held in the user equipment relating to the plurality of reference points may include information related to an expected change in motion at the reference points, so that a match between the expected change in motion and the expected change in motion may aid reliability of the recognition of the reference point. For example, a turn may be a left turn or a right turn, or the change in motion may involve the apparatus being stationary at a work place or waiting at a lift shaft. This may relate to an expected output or change of output of at least one of said sensor or sensors at at least one reference point. The information may includes a plan of a geographical area, for example a plan of a building.

The first estimate of the location of the apparatus may be determined by a method including the use of a measurement of received signal strength of at least one radio signal. For example, the detection of a radio signal known to be available at a given location may aid the estimate of the first location. Triangulation between known locations of radio transmitters, such as wireless access points, may aid the first estimate of the location of the apparatus. Data may be available relating to the location and signal strength of wireless access points from a MIH server.

The user equipment may be located within a building, but a wireless access point may be located outside the building. If a wireless access point is outside a building, it may be received within a building at a limited number of locations, due to attenuation of radio signals through the walls, for example, and so the receipt of the signal may assist location.

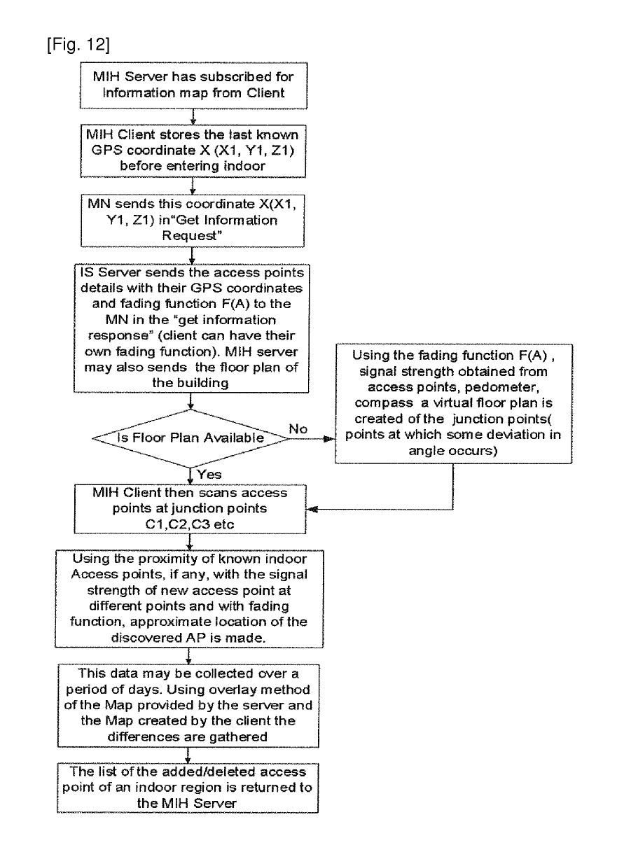

Information relating to a location of a limitation to movement, such a map of wall locations, may be downloaded from the server system The location of limitations to movement, such as locations of walls, may be used to refine the first estimate of location, since it may be assumed that locations outside the limits of movement are in error. Floor plans of a building may be downloaded from a server system, which may include locations of reference points at which a change of floor is expected. Recognition of these reference points, combined with estimates of the motion of the user equipment provide a convenient method of determining on which floor of a building an apparatus is located, without relying only on an altimeter reading, which may be unreliable. FIG. 12 illustrates a method of generating a floor plan.

The tracking of position using sensors may be disabled to save battery life, but reenabled on recognition that a predetermined position has been reached by the detection of an output of a sensor. For example, a change in motion may be detected or a radio signal may be detected. Also, the loss of GPS signal may be used to trigger the tracking of position. Also, the determination of the first estimate of location may be restricted to an idle mode or super-idle mode, in which usage of a resource such as processor capacity or a communication resource is below a determined limit.

The user equipment may be used to generate information relating to reference points at which a change in motion of an apparatus is expected, and then either simply hold it at the user equipment or upload it to a server, such a MIH server. This is performed by a similar method to that used to determine a position: a change in motion of the apparatus is detected by use of a sensor or sensors in the apparatus, then a first estimate is determined of the location of the apparatus at which said change of motion is detected, relative to a previously determined location, by use of at least one of said sensor or sensors, such as the accelerometer and compass. Previously generated information is held relating to reference points corresponding to previously detected locations at which a change in motion of the apparatus has been detected. It is then determined that the detected change in motion relates to a first reference point by comparing the first estimate of the location and the previously generated information. Then the previously generated information relating to the first reference point is updated in view of the first estimate of the location and a previous estimate of the location of the first reference point. In this way random errors may be reduced by combining many estimates of the location of the reference points. The updating is performed by averaging the previously generated information relating to the first reference point and the first estimate of the location. Various types of averaging may be used, such as a weighted average, which may increase the accuracy of the estimate of positions of reference points, by incorporating a large number of data points.

Information relating to a location of a limitation to movement may also be uploaded to a server system. The location of limitations to movement may correspond to a location of a wall of a building. The information relating to limits of movement may be compiled on the basis of a history of movement of the apparatus; it may be assumed that areas which are not visited in an extended period are outside a limit of movement, for example outside a building.

User equipment of a wireless network may be used for updating a stored database of fixed wireless nodes at a MIH server, the fixed wireless nodes being wireless access points in a wireless network that includes a cellular radio access network and also includes wireless hotspots provided by fixed wireless nodes that are part of a radio access network such as a WiFi network supporting IEEE802.11 radio access technology. The cellular radio access network may be for example a GERAN (GSM EDGE Radio Access Network, where GSM stands for Global System for Mobile communications and EDGE stands for Enhanced Data rates for GSM Evolution), UTRAN (Universal Terrestrial Radio Access Network), or E-UTRAN (Evolved-UTRAN) network, or a combination of these, using GERA, UTRA and E-UTRA radio access technology respectively. However, it will be understood that this is by way of example only and that other embodiments may involve wireless networks using other radio access technologies, such as WiMax networks supporting IEEE802.16 radio access technology; embodiments are not limited to the use of a particular radio access technology.

Embodiments are described using IEEE 802.21 Media Independent Handover (MIH) to assist handover between radio access networks. However, it will be understood that other service components for controlling handover between different radio access networks could be used in embodiments of the invention, such as Unlicensed Mobile Access (UMA), also known as Generic Access Network (GAN), which provides handover between IEEE 802.11 WiFi and GERA/UTRA, and Access Network Discovery and Selection Function (ANDSF), which typically contains data management and control functionality necessary to provision network discovery and selection assistance data and ANDSF is typically able to initiate data transfer to a user equipment, based on network triggers, and respond to requests from the user equipment

Media Independent Handover (MIH) is typically used for assisting handover of user equipment between radio access networks operating according to different radio access technologies, and MIH may also be used for handover between radio access networks operating using the same radio access technology, or between access nodes within a radio access network.

MIH may typically be implemented without changing the existing radio access networks, other than by the installation of MIH clients in network entities such as user equipment and wireless access nodes, and provision of the MIH server. The MIH server may also be referred to as a MIH information server.

A MIH client may make handover decisions, and in order to do this it would typically have access to information regarding the location of the user equipment, and would also obtain information from the MIH server relating to the location and capabilities of nearby wireless access nodes, such as cellular base stations and WiFi hotspots.

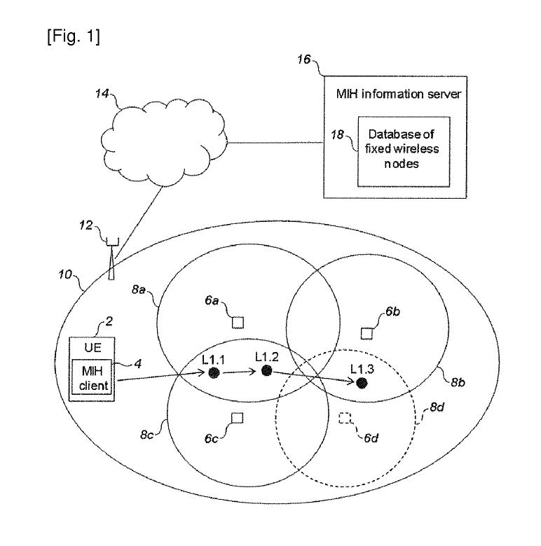

Embodiments of the invention will be described with reference to FIG. 1, which shows a wireless network including fixed wireless nodes 6a, 6b, 6c and 6d of a first radio access network, with areas of coverage 8a, 8b, 8c and 8d respectively. The areas of coverage may be referred to as WiFi hotspots, and the fixed wireless nodes may be wireless access points operating according to IEEE 802.11. The areas of coverage of the first radio access network are typically within the area of coverage 10 of a second radio access network, that may be a cellular radio access network such as GERAN/UTRAN or E-UTRAN, operating according to GERA/UTRA or E-UTRA radio access technology.

The second radio access network has a cellular fixed wireless node 12, that may be a cellular base station. The cellular fixed wireless node 12 is connected, via a telecommunications network 14, to a server system having a stored database 18 of fixed wireless nodes which are geographically dispersed.

The server system may be a server system which is used for controlling handover of user equipment between different radio access networks, such as a MIH server or MIH information server 16. The stored database 18 may include data relating to fixed wireless nodes of the first radio access network, the second radio access network, and other radio access networks. The description of wireless nodes as “fixed” need not imply that the nodes may never move, as may typically be the case with a wireless base station, but may also include the case of a movable wireless access point, such as a WiFi access point, that is temporarily situated in a location.

Due to the ad-hoc nature of many wireless networks, and in particular WiFi networks, there may be little or no central control or monitoring of the network. It may therefore be necessary to gather data for inclusion in the stored database of fixed wireless nodes by a process including a survey, that is to say to monitor broadcast signals received using a radio access technology appropriate to the radio access network of interest, and typically to derive identification data from the signals, and to derive signal strength information, such as received signal strength, from the broadcast signals. It is possible to update information in the data base by a process of drive testing, in which a vehicle suitably equipped with radio receivers is driven around an area of interest to gather data. However, this may be an expensive process, and requires regular repetition in order to maintain an up-to-date database.

In embodiments of the invention, user equipment is used to update the database, exploiting the tendency of users to move throughout an area of interest as they go about their business and leisure activities.

FIG. 1 shows a user equipment 2 moving on a path via geographical locations L1.1, L1.2 and L1.3.

The user equipment 2 has a radio transceiver for connecting to, or at least receiving signals from, a WiFi hotspot, that is to say the user equipment has a capability to communicate using IEEE802.11 radio access technology, referred to here as a first radio access technology. In addition, the user equipment 2 also typically has a radio transceiver for communicating using a second radio access technology, typically a cellular wireless technology such as GERA/UTRA or E-UTRA. The user equipment has access to the stored database 18 of fixed wireless nodes, typically via the second radio access network. However, in alternative embodiments, the access to the stored database 18 may alternatively or additionally be via the first radio access network.

The user equipment 2 has a capability to determine a geographical location. This may typically be provided by a navigation system, such Global positioning System (GPS), or another satellite navigation system, or a navigation system including terrestrial transmitters. The user equipment 2, as shown in FIG. 1, has a MIH client 4 installed, which is a service component used for controlling handover of user equipment between different radio access networks.

Three of the fixed wireless nodes 6a, 6b, 6c are represented in the database of fixed wireless nodes 18, and these nodes are depicted in FIG. 1 with unbroken lines. A fourth fixed wireless access node 6d, depicted in FIG. 1 with broken lines, is a new fixed wireless node that does not match an entry in the database of fixed wireless nodes.

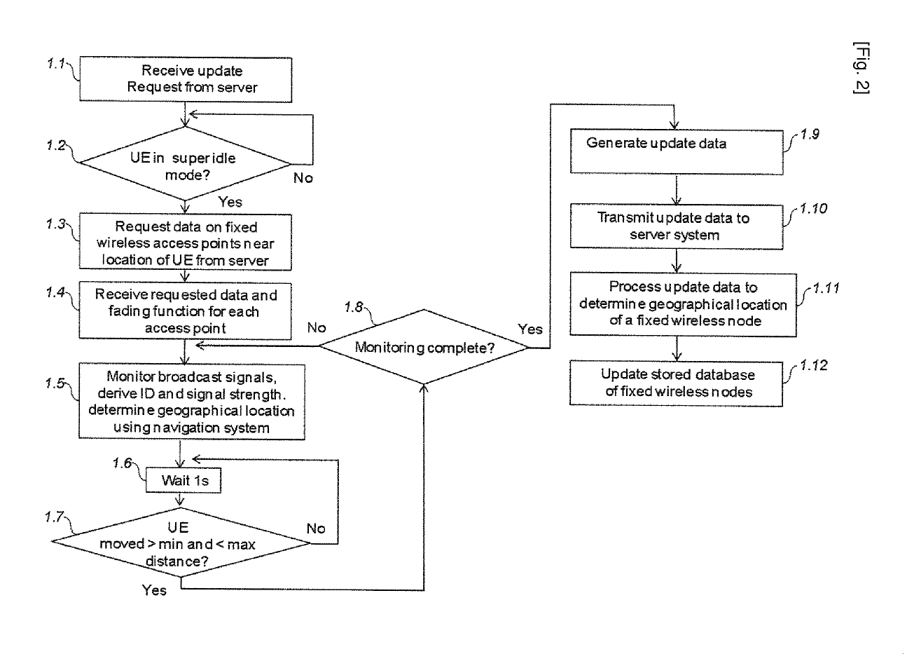

FIG. 2 is a flow diagram illustrating a first embodiment of the invention.

At step 1.1, the user equipment 2 receives an update request from a server system, typically a MIH information server 18. The update request is, in this embodiment, a message requesting that the user equipment monitor broadcast signals received using the first radio access technology. The update request may take the form of a subscription for a new event “Get Information indication” with the MIH client at the user equipment. When the MIH server has the required information from the MIH client, it can unsubscribe for the event with the mobile node. The user equipment may also monitor broadcast signals received using the second radio access technology and/or further radio access technologies in response to the receipt of the update request, since, as already mentioned, the stored database 18 may include data relating to fixed wireless nodes of the first radio access network, the second radio access network, and other radio access networks.

Typically, the server system sends the update request, having identified that information is required from the user equipment to update the stored data base. For example, the server system may have identified that the part of the stored database that covers the current location of the user equipment is due to be updated.

At step 1.2, it is determined whether or not the user equipment is in “super idle mode”. The term “super idle mode” means that utilisation of communication resources is below a threshold, so, for example, the user equipment may have no or limited calls in progress or data transfer in progress (which may be termed “idle mode”), and also indicates some other condition of the user equipment relating to the availability of resources at the user equipment (hence “super idle mode”). So, it may be determined that utilisation of a processor in the user equipment is below a threshold (for example CPU usage less than 30%), so that the user equipment is not being used for a processor-intensive application such as a game. Alternatively, or in addition, it may be determined that a condition relating to battery charge is above a threshold (for example greater than 80% of full battery charge). The presence of headphones may be detected at the user equipment and the detection may be used as an indication that the user has a call in progress, or that the user is using resources of the user equipment, such as processor resources, for example to play music or a game. The absence of the headphones may be used alone, or preferably in combination with another determination of a condition of the user equipment relating to the availability of resources at the user equipment, to determine that the user equipment is in super idle mode. A determination that the use of a grip sensor is below a threshold, preferably in combination with other indicators, may also be used to determine that the user equipment is in super idle mode. The use of a grip sensor may indicate that a user is using a function of the user equipment that is processor-intensive, for example.

In alternative embodiments, at step 1.2, it may be simply determined that the user equipment is in idle mode rather than super idle mode, or the determination may be simply of the utilisation of the processor or of an alternative condition of the user equipment relating to an availability of resources.

At step 1.2, the user equipment may delay proceeding to subsequent steps until a condition of the user equipment relating to the availability of resources changes.

At step 1.3, the user equipment 2 requests, from the server system, data relating to wireless nodes near to the location of the user equipment. This request may comprise sending to the server system the location of the user equipment, or alternatively the server system may already have information relating to the location of the user equipment.

At step 1.4, the user equipment receives the requested data from the server system. The requested data may be derived from at least part of the stored database of fixed wireless nodes.

At step 1.5, broadcast signals are monitored by the user equipment to derive identification data and signal strength data of fixed wireless nodes. In this embodiment a geographical position of the user equipment at which broadcast signals were received is determined using a navigation system. The navigation system may be a satellite navigation system, and/or a navigation system using terrestrial transmitting stations. User equipment often incorporates a navigation system such as GPS as a standard feature, so that the navigation system can be exploited for the purposes of generating update data at little additional cost.

Step 1.5 may be termed a monitoring event, and following this a delay may be imposed at step 1.6, typically of approximately one second. Values of delay in the range 100 ms to 10 seconds may be particularly suitable.

Following the delay, at step 1.7, it is determined, typically by use of the navigation system, whether the user equipment has moved by more than a minimum distance, and typically also whether the user equipment has moved less than a maximum distance. If the user equipment has not moved by more than the minimum distance, then the process flow returns to step 1.6 and the position is again determined at step 1.7 after a delay. For a delay of approximately 1 s, a minimum distance may be typically 1 m, and a maximum distance typically 10 m. If the movement is less than the minimum distance, then it may not be an economical use of resources to carry out a measurement, since the information would duplicate that of the previous measurement to a large extent. If the distance moved is greater than the maximum distance, then the user equipment may be moving too fast to obtain a reliable measurement.

If the user has moved more than the maximum distance and less than the minimum distance, then the flow may return to step 1.5 at which a further monitoring event is carried out.

Alternatively, an indication of speed may be obtained by other conventional means such as an output from a GPS receiver, and triggering of a monitoring event may be dependent on the indication of speed being between upper and lower bounds, for example between 1 m/s and 10 m/s. Triggering of a measurement event may be on the basis of a distance moved, for example 1 metre.

However, if the first monitoring event did not reveal any significant discrepancies between the data downloaded from the server system and the data derived from the monitoring event, an additional delay may be imposed before further monitoring. The additional delay may be typically 5 minutes.

It may be determined whether or not any significant discrepancies were revealed in the first monitoring event by the following process. The data downloaded from the server system may include at least part of the stored database of fixed wireless nodes held at the server system, so that the user equipment has a replica data base including the downloaded data. The user equipment is arranged to compare derived update data with the replica database and to determine from the comparison new fixed wireless nodes, if any, for which derived update data does not match an entry in the replica database and to determine from the comparison missing wireless nodes, if any, for which an entry in said replica database does not match derived identification data. Accordingly, it can be determined if new fixed wireless nodes have been added to the network since a previous update of the database, or if previously active nodes have become inactive or been removed or inaccessible. If it is determined that a wireless node or nodes have been added or been removed or become inactive or inaccessible, then this may be deemed a significant discrepancy.

If it is determined, at step 1.8, that the monitoring is complete, then update data is generated at step 1.9. The monitoring may be determined to be complete, for example, on the basis of an amount of data requested in the update request from the server at step 1.1.

The generation of update data at step 1.9, in the first embodiment, involves the generation of unprocessed or “raw” data, that is to say data that has not been processed to determine a position of a wireless node. The update data, in this embodiment, includes identification data, signal strength data, and geographical location data relating to one or more geographical locations of the user equipment at which broadcast signals were received. The upload of raw update data minimises the requirements on the processing resources at the user equipment.

At step 1.10, the user equipment transmits the update data to the server system.

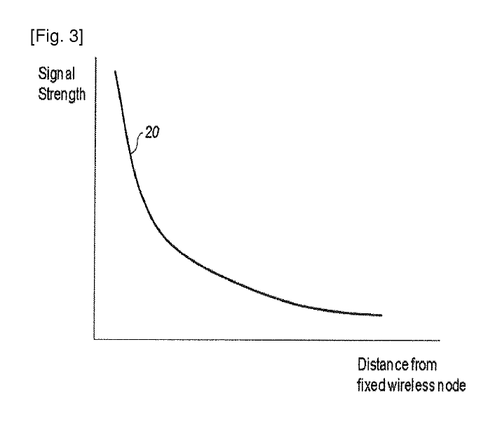

At step 1.11, the update data is processed, typically at the server system, to determine a geographical location of a fixed wireless node, such as a fixed wireless node is a node that has been added to the network, so that its position is not known. The position may be determined on the basis of a relationship between received signal strength and distance from a fixed wireless node, that is to say on the basis of a fading function. A typical relationship between signal strength and distance from a fixed wireless node is shown by the curve 20 of FIG. 3. The fading function may be a previously measured relationship for a wireless node of a given type using a given radio access technology, or a theoretical relationship.

Knowledge of the received signal power at a series of known geographical locations and the fading function may be used to solve for the unknown position of the fixed wireless node. The greater the number of measurements, the greater the accuracy with which the position of the fixed wireless node can be determined. If sufficient measurements are available, then the unknown position of the fixed wireless node may be estimated without prior knowledge of the fading function.

At step 1.12, the stored database of wireless nodes is updated on the basis of the update data and the processed update data. For example, the geographical position of a fixed wireless node that has been added to the first radio access network may be included in the update.

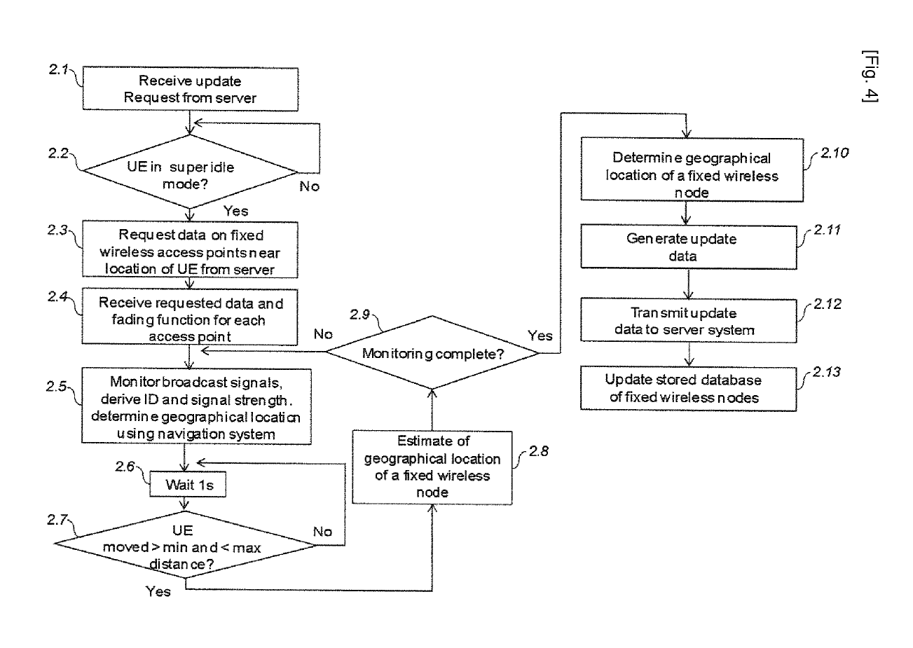

FIG. 4 is a flow diagram illustrating a second embodiment of the invention. The second embodiment differs from the first embodiment in that the processing to determine the geographical position of a fixed wireless node is carried out at the user equipment, rather than at the server system. In order to assist the determination, a fading function may be downloaded to the user equipment. However, as previously noted, if sufficient measurements are available, then the unknown position of the fixed wireless node may be estimated without prior knowledge of the fading function. By processing at the user equipment, the processing load on the server system may be reduced, and the amount of data uploaded from the user equipment to the server system may also be reduced.

Steps 2.1 to 2.3 of FIG. 4 are similar to steps 1.1 to 1.3 of FIG. 2. At step 2.4, a fading function may be downloaded to the user equipment from the server. Alternatively, a fading function stored in the user equipment may be used.

Steps 2.5 to 2.7 of FIG. 4 are similar to steps 1.5 to 1.7 of FIG. 2.

At step 2.8, a geographical location of a fixed wireless node is determined at the user equipment, by similar processing to that described in connection with the first embodiment in relation to step 1.11. This may take the form of an estimate of geographical location that is refined iteratively with successive measurement events. Alternatively, step 2.8 may be omitted, and the geographical location may be determined at step 2.10 on completion of monitoring.

At step 2.9 it is determined whether monitoring is complete, similarly to step 1.8.

At step 2.10, a geographical location of a fixed wireless node is determined at the user equipment. This may be on the basis of an estimate derived at step 2.8, or may be by similar processing to that described in connection with the first embodiment in relation to step 1.11.

At step 2.11, update data is generated, including the location of a fixed wireless node, and at step 2.12, the update data is transmitted to the server system.

At step 2.13, the stored database of wireless nodes is updated on the basis of the update data and the processed update data.

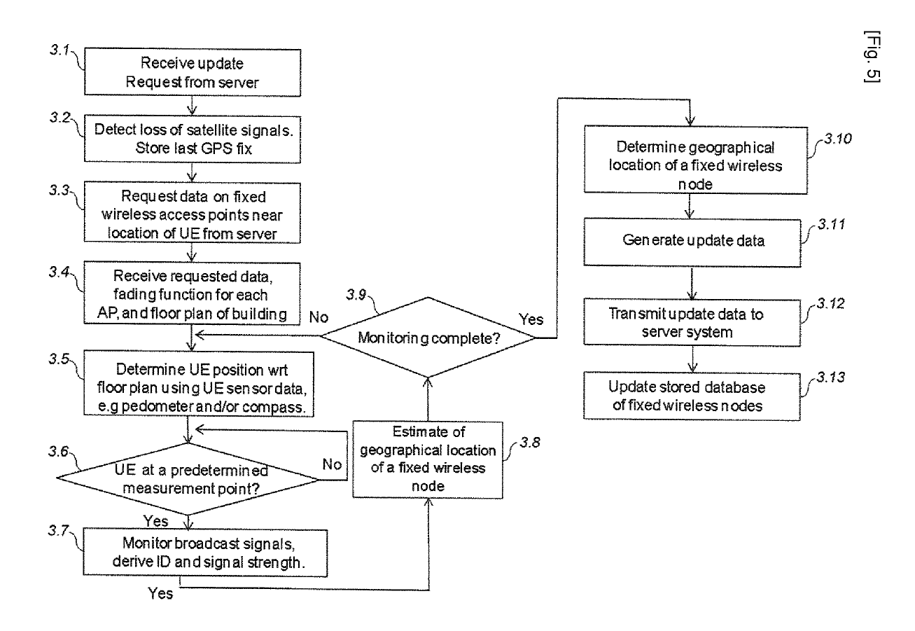

FIG. 5 is a flow diagram illustrating a third embodiment of the invention.

The third embodiment of the invention relates in particular to indoor navigation, in the case where a navigation system such as a satellite navigation system may not function due to the unavailability of received signals. Therefore, it is necessary to determine the position of the user equipment at the monitoring locations, and to determine when the user equipment should monitor broadcast signals, when the navigation system is unavailable.

The third embodiment specifically relates to the case where a plan of a building in which the user equipment is located is downloaded from the server system. The position of the user equipment may be determined with respect to the plan by use of measurements of the motion of the user equipment, that may use sensors in the user equipment such as an accelerometer, compass, altimeter and/or pedometer, preferably with reference to a known starting point determined using the navigation system. The information in the plan may include positions of internal and external walls, locations of fixed wireless nodes (including which floor of the building on which they are located) and locations of preferred monitoring locations. The position of the user equipment may also be determined on the basis of the signal strength and/or fading functions of the known fixed wireless nodes.

The location of any new fixed wireless nodes such as access points may then be determined on the basis of the monitoring of broadcast signals and on the basis of the locations of the user equipment at which monitoring took place. The locations of new access points may be expressed in relation to the plan, for example by including a designation of a floor on which they are located. The locations of the new fixed wireless nodes may then be uploaded to the server system for use in updating the database of fixed wireless nodes.

The plan may also be used to determine the location of the user equipment for purposes unconnected with the updating a database of fixed wireless nodes.

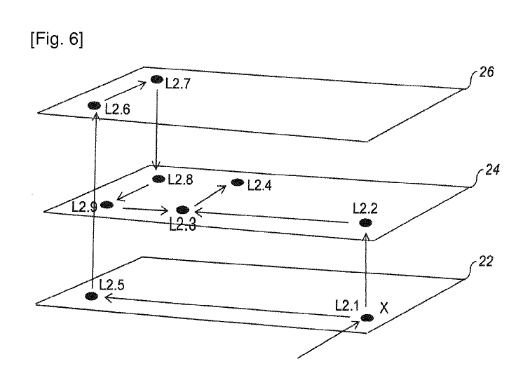

The operation of the third embodiment will be described with reference to FIG. 6, which shows a path taken by the user equipment within a building.

At step 3.1, similar to step 1.1, the user equipment receives an update request from the server system.

At step 3.2, the user equipment detects a loss of satellite signals, or terrestrial navigation signals if appropriate, and stores the last position determined by the navigation system. Typically, the loss of satellite signals may be declared if signals are available from less than three satellites. Referring to FIG. 6, the loss of satellite signal may occur at location L2.1, which is the location of the entrance of the building.

At step 3.3, the user equipment requests data on fixed wireless nodes, which may be wireless access points, near the location of the user equipment. The user equipment may also indicate to the server system that it has moved indoors, based on the loss of satellite signals. Communication to the server system may be via the second radio access network, which may be more robust to indoor operation than the navigation system.

At step 3.4, the user equipment receives the requested data, that may include parts of the stored database of wireless nodes, and in addition the user equipment may receive a fading function. The fading function may be a generic function appropriate to the radio access technology of the signals that are monitored, or may be a function, such as a measured function, for each wireless node.

In addition, in the third embodiment, a plan of a building is downloaded from the server at step 3.4. The plan may show the positions of known wireless access nodes 6a, 6b and 6c, and may also show internal and external walls. The plan may be referred to as a floor plan. The coordinates used in the plan may be GPS coordinates, and these coordinates may be used in addition to the designation of a floor, such as “first floor”, “second floor” and so on. The plan may also show predetermined monitoring locations, which are locations at which monitoring of broadcast signals may be triggered. The monitoring locations may be chosen to be sufficiently far apart to ensure that measurements are not taken unnecessarily, and may be conveniently located at turning points on the floor plan, such as corners of corridors.

At step 3.5, the location of the user equipment is determined with respect to the plan by the use of data derived from sensors in the user equipment. The sensors may be for example a pedometer, a compass, accelerometer and/or an altimeter. Data derived from the sensors may be used to derive relative navigation data, such as data relating to a position relative to the last the last position determined by the navigation system; this may be the last GPS fix.

The determination of location of the user equipment position at step 3.5 may alternatively or additionally be performed on the basis of monitoring of the broadcast signals from wireless access nodes. Knowledge of the received signal strength and the fading function for the signal from fixed wireless nodes, together with the transmit power of the fixed wireless nodes, allows the location of the user equipment to be estimated.

The estimate of the location may be further refined by use of the plan. For example, a determination of location of the user equipment based on measurements from two fixed wireless nodes may be ambiguous, that is to say there may be two or more possible solutions. Reference to the plan may indicate that one location is more likely to be correct than another, as, for example, one of the candidate locations may be outside the building. Furthermore, it may be required that the determined location is on a designated part of the plan, and if it is not then the position estimate may be corrected accordingly.

Estimates of the location of the user equipment derived from the monitoring of signals received from fixed wireless nodes may be combined with estimates of the location derived from the sensors in the user equipment.

Continuing to refer to the flow chart of FIG. 5, at step 3.6, it is determined whether or not the user equipment is at a predetermined measurement point. If it is, broadcast signals are monitored at step 3.7 to derive identification and signal strength data. The monitoring may be dependent on at least one condition of the user equipment relating to the availability of resources at the user equipment, as in the first embodiment.

At step 3.8, the geographical position of a fixed wireless node is determined, typically a node that has been added to the network and does not feature in the data downloaded from the server system at step 3.4, such as wireless node 6d in FIG. 7. The determination may be an estimate that is refined iteratively on the basis of successive monitoring events. The determination may be on the basis of measurements of broadcast signals taken at a number of locations of the user equipments, typically using a fading function. The locations of the user equipment at which the measurements are taken may have been determined by the process of step 3.5. Alternatively, step 3.8 may be omitted, and the geographical location may be determined at step 3.10 on completion of monitoring.

If it is determined at step 3.9 that the monitoring process is not complete, similarly to the process at step 1.8, then determination of the user equipment position at step 3.5 is repeated.

If the monitoring process is complete, then the process proceeds to step 3.10, and the geographical position of the fixed wireless node is determined, The determination may be on the basis of an estimate already derived at step 3.8, if the iterative approach has been taken. Similarly to step 3.8, the determination may be on the basis of measurements of broadcast signals taken at a number of locations of the user equipments, typically using a fading function. The locations of the user equipment at which the measurements are taken may have been determined by the process of step 3.5.

At step 3.11, update data is generated that may include the geographical location of a fixed wireless node.

At step 3.12, the update data is transmitted to the server system.

At step 3.13, the stored database of wireless nodes is updated on the basis of the update data.

As a variant of the third embodiment, the geographical location of a fixed wireless node may be calculated at the server system, similarly to the first embodiment, rather than at the user equipment. In this case the update data may include location data related to the locations at which monitoring of broadcast signals was performed.

The method of identifying the position of the user equipment in the third embodiment of the invention may be used as a means of indoor navigation independently of a process for the update of a stored database of fixed wireless nodes. Indoor navigation may, furthermore, be enhanced by the following techniques.

The floor on which the user equipment is located may be determined by monitoring broadcast signals from fixed wireless nodes such as access points, together with the known floor designation for the nodes, which may be obtained from the downloaded plan. For example, a fading function may be assumed to show less attenuation within a floor than for the same distance vertically between floors.

Alternatively or additionally, a pattern of movement may be used to recognise a floor based on an expectation based on past movements of user equipment according to the floor. For example, a template of likely movement may be maintained for each floor. The template may, for example, be included as part of the plan.

The determination that the user equipment has followed a path that includes a location associated with changing floors, such as stairs or an elevator or lift, may be taken as an indication that a change of floors is likely, and may be used in combination with another indicator to determine the floor on which the user equipment is located.

Communication with other user equipment, such as by peer-to-peer communication, may be used to access information relating to the floor where the other user equipment is located. For example, the other user equipment may have a sensor, such as an altimeter. It may be determined that the other user equipment is on the same floor as the user equipment whose location is to be determined, on the basis of a received signal strength of signals from the other equipment or on the basis that a short range communication channel is functioning.

An access point in the building may broadcast data indicating on which floor it is located, and the user equipment may then determine the floor on which the user equipment is located on the basis of the signal strength received from the access point.

The accuracy of relative positioning within a floor of a building may be improved by the use of reference points of known location. For example, a compass and accelerometer and/or pedometer may be used for relative navigation to identify a relative location of the user equipment with respect to a known initial reference point, such as the position of last GPS fix. The user equipment may then move into the vicinity of a second recognisable reference point; if the identity of the second reference point is verified to an acceptable degree of certainty, it may then be used as the basis of further relative navigation. By this process, the accumulation of errors in the relative navigation process is minimised. Suitable reference points include a building entrance (that may correspond to the position of last GPS fix), and an location associated with a change of floor, such as stairs or a lift/elevator (that may be verified by an associated change in altitude or a verified subsequent floor change). In addition, characteristics of signals received from one or more fixed wireless nodes such as access points may be used to identify a reference point, for example a change in signal strength may be recognised. A change in signal strength may be associated with a particular location due to an obstruction of the signal, for example.

It may be useful to determine whether a user equipment is moving or stationary, and indeed to estimate the speed of any motion. This information may be useful, for example, in determining whether or not monitoring broadcast signals from fixed wireless nodes should be enabled for the purposes of updating a database of fixed wireless nodes, or for aiding the accuracy of relative navigation.

In order to identify whether or not the user equipment is stationary and potentially to estimate the speed of any motion, one or more of several techniques may be employed, as follows.

A camera on the user equipment may be used to view the surroundings, and changes in the image formed by the camera may be detected.

A change in audio noise level may be detected using a microphone at the user equipment.

A change in signal level received from one or more fixed wireless nodes may be detected.

Activity at the user equipment associated with movement of the user equipment may be identified, such as the display being on or off. It may be more likely that a display is on when the user equipment is stationary.

Output from a movement sensor in the user equipment such as a pedometer or accelerometer may be used to detect movement, and a change in the output from a compass or altimeter may also indicate movement.

Combinations of indicators of movement may be used to increase confidence in the indication; for example, an indication of acceleration from an accelerometer in combination with the display being off may be a good indicator that the user equipment is moving.

In order to identify whether or not movement of the user equipment corresponds with a change of floors, a short stationary period (that may be in a lift) may be an indicating factor, that may be in combination a location of the user equipment corresponding with the stairs of lift. A change in one of the factors indicating a floor, as already mentioned, would be a further indicating factor that a movement involved a change of floors.

Turning to FIG. 7, this is a flow diagram illustrating a fourth embodiment of the invention. The fourth embodiment, in common with the third embodiment, relates in particular to indoor navigation, but the fourth embodiment relates to the case in which a plan of the building is unavailable from the server system. In this case, the user equipment is arranged to compile a plan, on the basis of a history of movement of the user equipment. The history of movement may be recorded over a period of several days, for example. When the plan is compiled, it may be uploaded to the server system. The compiled plan may be used for determining a location of the user equipment in a similar manner to the downloaded floor plan of the third embodiment.

The plan may alternatively be compiled at the server system, on the basis of data uploaded to the server system from one or more user equipments. For example, a history of movement within the building may be uploaded from each of several user equipments, or from one user equipment on several occasions, and a composite plan of the building may be compiled at the server system. Over time, the plan may be refined by successive updates.

Referring to FIG. 7, steps 4.1 to 4.3 are similar to steps 3.1 to 3.3 described in relation to the third embodiment.

At step 4.4, requested data is downloaded relating to fixed wireless nodes, but a plan is unavailable. The user equipment starts a process of compiling a plan in dependence on the determination that a plan is unavailable. The user equipment may alternatively start compiling a plan dependent on a request from the server system.

At step 4.5, a process is carried out to detect a turning point. A turning point is a location at which the direction of travel of the user equipment changes by more than a predetermined amount, for example the predetermined amount may be 20 degrees, but values in the range 10 degrees to 80 degrees may be particularly beneficial. The change in direction may be detected by use of a compass. Turning points of a building may be easily and repeatably determined, and as a result they are particularly suitable for use as locations for monitoring of broadcast signals from fixed wireless access points repeatedly for a number of trips.

At step 4.7, broadcast signals from fixed wireless nodes are monitored and identification data and signal strength data is derived. The monitoring may be dependent on at least one condition of the user equipment relating to the availability of resources at the user equipment, as in the first embodiment.

At step 4.8, a plan is created and refined in successive iterations. The process of creating and refining the plan may be illustrated by reference to FIG. 6. In this first example, the plan in question is a map showing identified turning points, which may be preferred monitoring locations, within a building.

A user of the user equipment may work in the building represented by FIG. 6; three floors are shown. The user enters the building on the ground floor 22 at location L2.1, which is the location of last GPS fix. On the first day, the user ascends in the lift to the first floor 24, and turns on leaving the lift at location L2.2, which is determined to be a turning point based on measurements from the compass, triggering monitoring of broadcast signals. The location of L2.2 can then be determined on a basis that may include the monitoring of broadcast signals, and preferably also on the basis of data derived from the altimeter and/or an accelerometer.

The accelerometer may be used as a pedometer, identifying a distance travelled in terms of number of steps taken. The compass is used to identify the orientation of movement.

The user then moves to position L2.3. At L2.3, the user turns, triggering another monitoring event from which the location can be determined. The user then moves to location L2.4, which is the normal working location for the user, so that in practice multiple monitoring events may be triggered during the day, from which the location of L2.4 can be determined. Position L2.4 may be treated as a reference point, in that it may be assumed that if the user spends an extended period in the vicinity of L2.4, it is probable that the user is actually at the normal working location, so the position may be reset to a location of L2.4 which has been determined with more accuracy than the current position over previous iterations. In this way, accumulated errors in the relative navigation system are reduced. Identification of other reference points, such as stairs or a lift, in a manner similar to that described in connection with the third embodiment may also be used to reduce the effect of accumulated errors in determination of location.

Also, the accuracy of the determination of the location of L2.4 may be enhanced over several iterations by combining the results of several determinations.

FIG. 6 also shows a path taken by the user on a second trip, in this case the user enters the building at L2.1, but this time moves to L2.5, turning, triggering a monitoring event, and then ascending in a lift to the second floor 26. Monitoring events are then triggered as the user turns at locations L2.6, L2.7, descends to L2.8 and turns, moves to L2.9 and turns, and turns again at L2.3, to get to the normal place of work at L2.4.

The distance between turning points may be calculated by means of a pedometer and/or an assumption of average speed and a timed interval. The measurements from the pedometer and/or the compass may be combined with those derived from the access points to refine the location estimation.

It can be seen that over a number of different trips, measurements may be carried out at various parts of the building and that many of the paths followed will be repeated day-to-day, allowing an average position to be calculated for turning points, or other reference points, which may have enhanced accuracy.

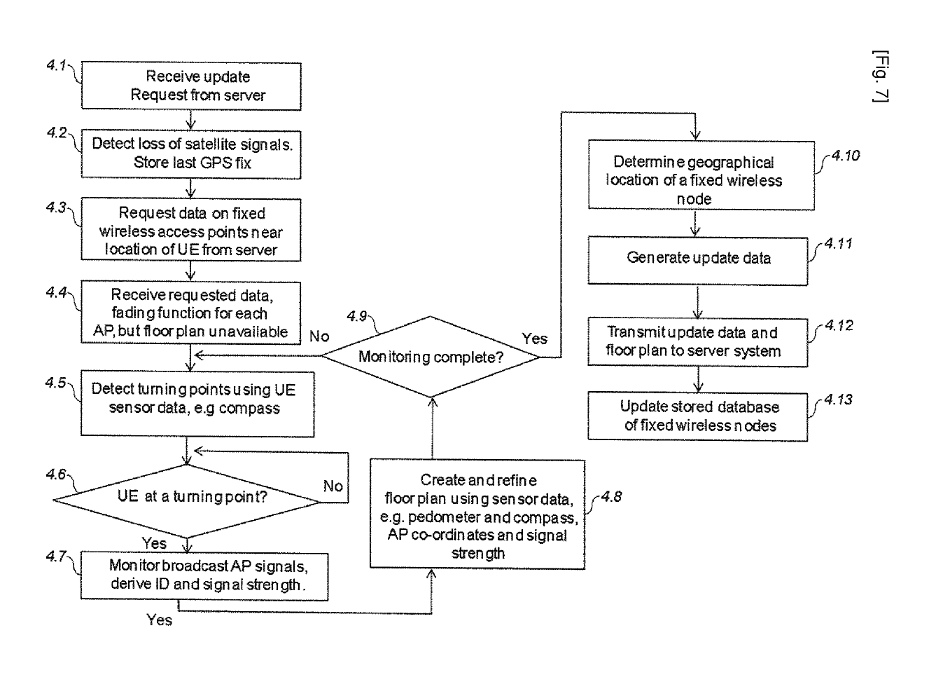

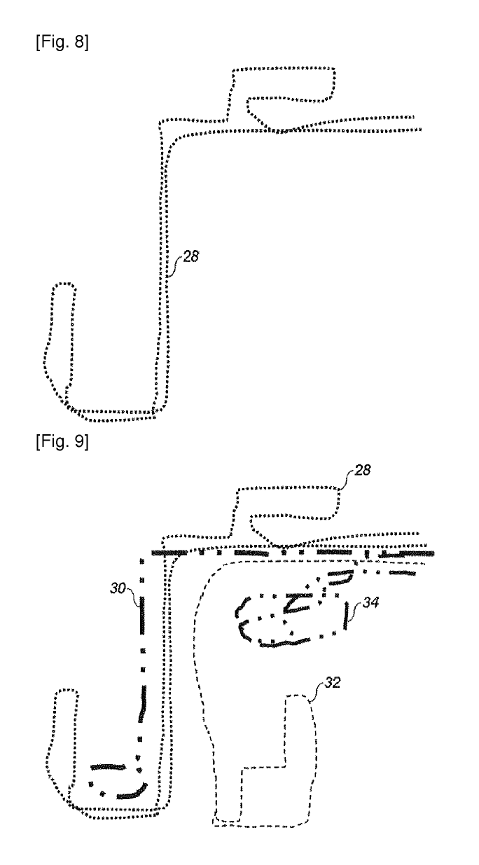

FIG. 8 shows a path 28 determined by a user equipment within a building, determined for example by the use of a pedometer and compass. The data describing the path 28 may be used at the user equipment to compile a plan, or may be uploaded to the server system so that the server system may compile a plan.

FIG. 9 shows four paths 28, 30, 32, 34 taken within the building. The paths may be successive trips taken by the same user equipment, or may be paths taken by several user equipments.

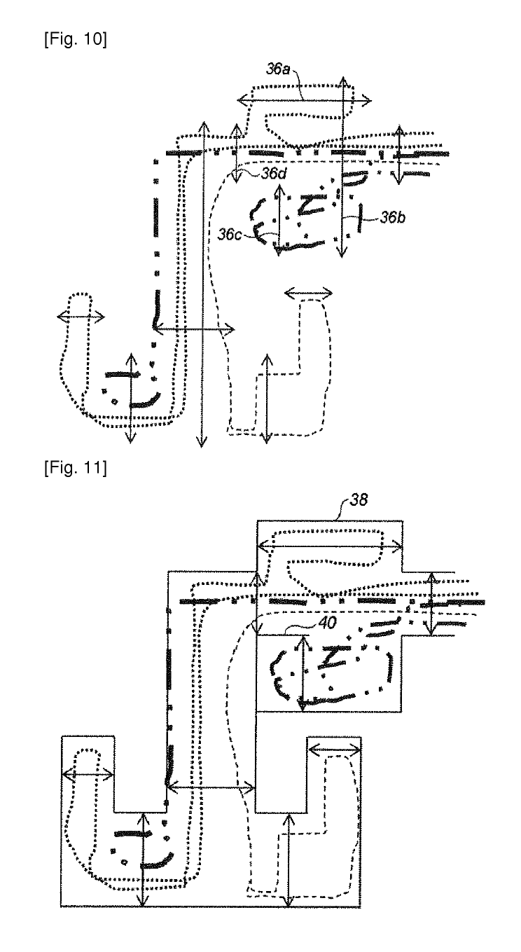

FIG. 10 illustrates how a plan may be compiled using the data describing the paths of FIG. 9. It can be seen that the overlay of the paths makes use of at least a known reference point at the start of each path, that may be an entry point to the building or the point of last GPS fix. The maximum extreme points of consecutive movement across a floor are determined, in order to build up an estimate of wall positions. In FIG. 9, ranges of movement are identified by for example ranges 36a, 36b, 36c and 36d. It can be seen for example, that locations of user equipment have been detected throughout the range 36b, but there is a gap between the ranges 36c and 36d which none of the paths have crossed. It may be estimated, therefore, that there is a wall or some other obstruction between the ranges 36c and 36d.

FIG. 11 shows estimated positions of internal and external walls of a building, based on the paths shown in FIG. 9 and the determination of extreme points of consecutive movement across a floor of FIG. 10.

It should be noted that the process of compiling a plan of a building need not involve monitoring broadcast signals from fixed wireless nodes, and may be carried out for purposes other than for determining the position of a fixed wireless node; for example, the plan may be generated to aid navigation within a building.

Returning to the flow diagram of FIG. 7, at step 4.9 it is decided whether the monitoring is complete, similarly to step 1.8.

Steps 4.10 to 4.13 proceed in a similar manner to steps 3.10 to 3.13, which have been described with reference to FIG. 5, except that the compiled plan, which may be a floor plan, may be uploaded to the server system at step 4.12.

The above embodiments are to be understood as illustrative examples of the invention. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method of determining a location of an apparatus relative to a previously determined location, the method comprising:
detecting a change in motion of the apparatus using a sensor in the apparatus;
determining a first estimated location of the apparatus where said change of motion is detected, the first estimated location being relative to the previously determined location, using the sensor;
holding information relating to a plurality of reference points at which a change in motion is expected;
determining whether the detected change in motion relates to a first reference point of the plurality of reference points based on the first estimated location and part of said information relating to the plurality of reference points; and
re-setting the first estimated location to a location of the first reference point.

2. The method according to claim 1, wherein said detecting of the change of motion is based on a change in direction detected by a compass.

3. The method according to claim 1, wherein said detecting of the change of motion is based on a change in velocity by an accelerometer.

4. The method according to claim 1, wherein said detecting of the change of motion is based on a change in altitude by an altimeter.

5. The method according to claim 1, the method further comprising:
downloading said information relating to the plurality of reference points from a server system.

6. The method according to claim 5, wherein the server system is a media independent handover (MIH) server system.

7. The method according to claim 1, wherein said information relating to the plurality of reference points relates to a location of each of the reference points.

8. The method according to claim 1, wherein said information relating to the plurality of reference points includes information related to an expected change in motion from at least one reference point.

9. The method according to claim 1, wherein said information relating to the plurality of reference points relates to an expected output or change of output of said sensor from at least one reference point.

10. The method according to claim 1, wherein said information includes information of a geographical area.

11. The method according to claim 1, wherein said information relates to a building plan.

12. The method according to claim 1, wherein said sensor includes at least one of a compass, an accelerometer, a pedometer and an altimeter.

13. The method according to claim 1, further comprising:
determining the first estimated location of the apparatus using a measurement of a received signal strength of at least one radio signal.

14. The method according to claim 1, further comprising:
determining whether the detected change in motion relates to the first reference point based on a measurement of the received signal strength of at least one radio signal.

15. The method according to claim 13, wherein said information relating to the plurality of reference points includes information relating to the received signal strength of at least one radio signal.

16. The method according to claim 13, wherein said at least one radio signal is received from a wireless access point.

17. The method according to claim 16, wherein the apparatus is located within a building and said wireless access point is located outside the building.

18. The method according to claim 13, further comprising:
downloading information relating to locations of a plurality of wireless access points from a server system; and
determining the first estimated location of the apparatus from a measurement of received signal strength of a radio signal received from at least one of said plurality of wireless access points and a location of said at least one of the plurality of access points.

19. The method according to claim 1, further comprising:
downloading information relating to a location of limited movement from a server system; and
determining the first estimated location of the apparatus by reference to said limited movement.

20. The method according to claim 19, wherein said location of limited movement corresponds to a location of a wall of a building.

21. The method according to claim 1, further comprising:
downloading information relating to a plurality of floor plans of a building from a server system, said information relating to the plurality of floor plans of a building including a location of a reference point at which a change of floor is expected; and
determining a floor on which the apparatus is located based on whether the first reference point corresponds to a reference point at which a change of altitude is expected and a history of movement of the apparatus.

22. The method according to claim 1, the method comprising:
determining the first estimated location of the apparatus based on an output of said sensor.

23. The method according to claim 1, the method comprising:
determining the first estimated location of the apparatus from at least one predetermined condition of user equipment relating to availability of resources at the user equipment.

24. An apparatus arranged to determine a location relative to a previously determined location, wherein the apparatus is arranged to detect a change in motion of the apparatus using a sensor in the apparatus, to determine a first estimated location of the apparatus where said change of motion is detected, with the first estimated location being relative to the previously determined location, using the sensor, to hold information relating to a plurality of reference points at which a change in motion is expected, to determine whether the detected change in motion relates to a first reference point of the plurality of reference points based on the first estimated location and part of said information relating to the plurality of reference points, and to re-set the first estimated location to a location of the first reference point.

25. The apparatus according to claim 24, wherein the apparatus is a user equipment of a wireless communication network.

26. A method of generating information relating to a plurality of reference points at which a change in motion of an apparatus is expected, the method comprising:
detecting a change in motion of the apparatus using a sensor in the apparatus;
determining a first estimated location of the apparatus where said change of motion is detected, the first estimated location being relative to a previously determined location, using the sensor;
holding previously generated information relating to plurality of reference points, with the plurality of reference points corresponding to previously detected locations at which a change in motion of the apparatus has been detected;
determining whether the detected change in motion relates to a first reference point of the plurality of reference points based on the first estimated location and the previously generated information;
updating the previously generated information relating to the first reference point based on the first estimated location and a previous estimate of the location of the first reference point; and
generating updated information relating to the plurality of reference points.

27. The method according to claim 26, wherein said updating is performed by averaging the previously generated information relating to the first reference point and the first estimated location.

28. The method according to claim 27, wherein said detecting of the change of motion is based on detecting a change in direction using a compass.

29. The method according to claim 26, wherein said detecting of the change of motion is based on detecting a change in velocity using an accelerometer.

30. The method according to claim 26, wherein said detecting of the change of motion is based on detecting a change in altitude using an altimeter.

31. The method according to claim 26, wherein said updated information relating to the plurality of reference points includes information related to an expected change in motion from at least one reference point.

32. The method according to claim 26, wherein said updated information relating to the plurality of reference points relates to an expected output or change of output of the sensor from at least one reference point.

33. The method according to claim 26, wherein said updated information includes information of a geographical area.

34. The method according to claim 26, wherein said updated information relates to a building plan.

35. The method according to claim 26, the method further comprising:
uploading said updated information relating to the plurality of reference points to a server system.

36. The method according to claim 35, wherein the server system is a media independent handover (MIH) server system.

37. The method according to claim 26, wherein said sensor includes at least one of a compass, an accelerometer, a pedometer and an altimeter.

38. The method according to claim 26, further comprising:
determining the first estimated location of the apparatus by use of a measurement of received signal strength of at least one radio signal.

39. The method according to claim 26, further comprising:
determining that the detected change in motion relates to the first reference point based on a measurement of received signal strength of at least one radio signal.

40. The method according to claim 38, wherein said information relating to the plurality of reference points includes information relating to received signal strength of at least one radio signal.

41. The method according to claim 38, wherein said at least one radio signal is received from a wireless access point.

42. The method according to claim 41, wherein said apparatus is located within a building and said wireless access point is located outside the building.

43. The method according to claim 38, further comprising:
uploading information relating to locations of a plurality of wireless access points to a server system.

44. The method according to 26, further comprising:
uploading information relating to a location of limited movement to a server system.

45. The method according to claim 44, wherein said location of limited movement corresponds to a location of a wall of a building.

46. The method according to claim 44, further comprising:
compiling said information relating to limits of movement based on a history of movement of the apparatus.

47. The method according to claim 26, comprising:
generating a floor plan of a building based on a history of movement of the apparatus, and depending on the identification of a reference point at which a change of altitude has been measured; and
uploading information relating to a floor plan of a building to a server system, said information relating to a floor plan of a building including a location of a reference point at which a change of floor is expected.

48. The method according to claim 26, further comprising:
determining the first estimated location of the apparatus based on an output of said sensor.

49. The method according to claim 26, further comprising:
determining the first estimated location of the apparatus from at least one predetermined condition of user equipment relating to availability of resources at the user equipment.

50. An apparatus arranged to generate information relating to a plurality of reference points at which a change in motion of the apparatus is expected,
wherein the apparatus is arranged to detect a change in motion of the apparatus using a sensor in the apparatus; to determine a first estimated location of the apparatus at which said change of motion is detected, with the first estimated location being relative to the previously determined location, using the sensor, to hold previously generated information relating to the plurality of reference points, with the plurality of reference points corresponding to previously detected locations where a change in motion of the apparatus has been detected; to determine whether the detected change in motion relates to a first reference point of the plurality of reference points based on the first estimated location and the previously generated information; to update the previously generated information relating to the first reference point based on the first estimated location and a previous estimate of the location of the first reference point, and to generate updated information relating to the plurality of reference points.

51. The apparatus according to claim 50, wherein the apparatus is a user equipment of a wireless communication network.

52. A processor arranged to process information relating to a plurality of reference points at which a change in motion of an apparatus is expected,
wherein the apparatus is arranged to detect a change in motion of the apparatus using a sensor in the apparatus and to determine a first estimated location of the apparatus where the change of motion is detected,
wherein the estimated location is relative to the previously determined location, and
wherein the processor is arranged to receive the first estimated location from the apparatus; hold previously generated information relating to the plurality of reference points, with the plurality of reference points corresponding to previously detected locations of change in motion of the apparatus; determine whether the detected change in motion relates to a first reference point of the plurality of reference points based on the first estimated location and the previously generated information; update the previously generated information relating to the first reference point based on the first estimated location and a previous estimate of the location of the first reference point, and generate updated information relating to the plurality of reference points.
